(19) United States
(12) Patent Application Publication
(10) Pub. No.: US 2023/0245880 A1
(43) Pub. Date: Aug. 3, 2023

(54) LIGHT IRRADIATION DEVICE

(71) Applicant: HAMAMATSU PHOTONICS K.K., Hamamatsu-shi (JP)

(72) Inventors: Hiroki TAKEUCHI, Hamamatsu-shi (JP); Kohei SUGITANI, Hamamatsu-shi (JP)

(73) Assignee: HAMAMATSU PHOTONICS K.K., Hamamatsu-shi (JP)

(21) Appl. No.: 18/098,802

(22) Filed: Jan. 19, 2023

(30) Foreign Application Priority Data
Jan. 28, 2022 (JP) 2022-011487

(51) Int. Cl. F21V 29/71; F21V 29/65

(52) U.S. Cl. CPC F21V 29/71; F21V 29/65

(57) ABSTRACT

A light irradiation device includes: a lamp that has a lamp back surface on which a lamp back surface electrode is provided, and a lamp major surface which faces the lamp back surface and on which a lamp major surface electrode is provided, and that emits light from the lamp back surface; a housing forming an internal space in which the lamp is disposed, together with a vacuum window that transmits the light emitted by the lamp; and a heat sink that discharges heat from the lamp. The heat sink is thermally connected to the lamp major surface. The housing includes a suction pipe joint serving as an inlet for compressed air to be supplied to the internal space, and a discharge pipe joint serving as an outlet for the compressed air that has received the heat from the heat sink.

### TECHNICAL FIELD

The present disclosure relates to a light irradiation device.

### BACKGROUND

A lamp that emits light in a desired wavelength band may be accommodated in a housing. The lamp can be protected by accommodating the lamp in the housing. In the configuration in which the lamp is accommodated in the housing, the light generated by the lamp passes through a window provided in the housing, and an object is irradiated with the light. From the viewpoint of irradiating the object with light of a desired intensity, suppressing attenuation of the intensity of the light from the lamp to the object is desirable. For example, the more the lamp is apart from the object, the easier the intensity of light attenuates. Therefore, a structure in which the lamp is brought as close to the object as possible is desirable. A window exists between the lamp and the object. As a configuration in which the lamp is brought close to the object, for example, there is a configuration in which the lamp is brought close to the window.

The lamp generates heat as loss when converting applied energy into light. The heat affects a normal operation of the lamp. Therefore, in order to continue to perform irradiation with light, cooling the lamp is required. For example, Japanese Unexamined Patent Publication No. 2015-230838 discloses a technique of cooling a lamp accommodated in a housing. The technique of Japanese Unexamined Patent Publication No. 2015-230838 blows cooling gas onto the lamp.

### SUMMARY

The higher the energy of light generated by the lamp is, the larger the amount of generated heat is. When the amount of the generated heat is large, if the ability to cool the lamp is not sufficient, cooling the lamp on a light emission side of the lamp, namely, on a side on which the lamp and a window face each other is also required. In this case, a space for cooling is required on the light emission side of the lamp. Therefore, a distance from the lamp to the window may be limited by the ability to cool the lamp. Therefore, in the technique disclosed in Japanese Unexamined Patent Publication No. 2015-230838, when the ability to cool the lamp is insufficient, setting the distance from the lamp to the window to be larger than a desired distance is required. Therefore, when the ability to cool the lamp can be increased, the distance from the lamp to the window can be set close to the desired distance.

The present disclosure describes a light irradiation device in which the ability to cool a lamp can be increased and the lamp and a window can be brought close to each other.

A light irradiation device according to one aspect of the present disclosure includes: a lamp that has a first surface on which a first electrode is provided, and a second surface which faces the first surface and on which a second electrode is provided, and that emits light from the first surface; a housing forming an internal space in which the lamp is disposed, together with a window member that transmits the light emitted by the lamp; and a heat discharge unit that discharges heat generated by the lamp. The heat discharge unit includes a heat sink thermally connected to the second surface. The housing includes an inlet portion serving as an inlet for a heat medium that is gas to be supplied to the internal space, and an outlet portion serving as an outlet for the heat medium that has received the heat from the heat sink.

The heat sink is thermally connected to the second surface of the lamp. When heat is removed from the second surface, a thermal gradient between the inside of the lamp and the second surface increases. As a result, the heat generated by the lamp is easily transferred toward the second surface. Therefore, the heat generated by the lamp can be actively discharged from the second surface. As a result, the ability to cool the lamp is increased. Therefore, the lamp and the window member can be brought close to each other.

The light irradiation device may further include a partition unit that partitions the internal space of the housing into a first space and a second space. The inlet portion may communicate with the first space. The outlet portion may communicate with the second space. According to this configuration, the flow of the heat medium can be limited in one direction from the inlet portion toward the outlet portion. As a result, the flow of the heat medium becomes smooth. As a result, the ability to cool the lamp is increased.

The lamp of the light irradiation device may be disposed in the second space. According to this configuration, the heat from the lamp can be efficiently released to the outside of the housing.

The partition unit of the light irradiation device may have a hole that guides the heat medium from the first space to the second space. According to this configuration, the first space and the second space can be partitioned off from each other. Further, the heat medium can be guided from the first space to the second space.

The partition unit of the light irradiation device may have a box shape. The first space may be an inside of the partition unit. The second space may be an outside of the partition unit. According to this configuration, the heat medium in the first space and the heat medium in the second space can be reliably separated from each other. As a result, it is possible to suppress an influence of the heat medium in the second space on the fresh heat medium that has entered the first space.

The light irradiation device may further include a support plate in electrical contact with the lamp. An inner peripheral portion of the support plate may be in contact with an outer peripheral portion of the lamp. An outer peripheral portion of the support plate may be in contact with the housing. According to this configuration, a desired potential can be applied to the lamp via the support plate and via the housing.

A first surface of the support plate of the light irradiation device may be in contact with the first electrode. According to this configuration, a desired potential can be applied to the first electrode of the lamp via the support plate and via the housing.

A second surface of the support plate of the light irradiation device may face the window member. A thickness of the inner peripheral portion of the support plate may be smaller than a thickness of the outer peripheral portion of the support plate. According to this configuration, the lamp can be brought close to the window member.

The light irradiation device may further include a frame member that sandwiches the window member, together with the housing. According to this configuration, the window member can be exchangeably fixed to the housing.

The window member of the light irradiation device may provide on a surface facing the frame member. The window member may include a shielding film to block the light. According to this configuration, a component disposed between the window member and the frame member can be protected from the light generated by the lamp.

A distance between the first surface of the lamp and the surface of the window member facing the first surface of the lamp in the light irradiation device may be 3 mm or less. The distance between the first surface of the lamp and the surface of the window member may be 1 mm or less. According to this configuration, it is possible to sufficiently suppress loss of the light emitted by the lamp.

### BRIEF DESCRIPTION OF THE DRAWINGS

FIG. 1 is a perspective view of a light irradiation device of the present disclosure.

FIG. 2 is an enlarged cross-sectional view showing a periphery of a flange ring.

FIG. 3 is a view schematically showing an upstream space and a downstream space.

FIG. 4 is an exploded perspective view showing a partition box.

FIG. 5 is a view schematically showing an upstream surface region and a downstream surface region.

FIG. 6 is a view showing a gap between a lamp and a transparent window.

FIG. 7 is a graph showing a light output of the lamp.

FIG. 8 is a perspective view showing an irradiation unit.

FIG. 9 is a perspective view showing a heat sink.

FIG. 10 is a plan view showing the heat sink.

FIG. 11 is a perspective cross-sectional view showing a spacer unit.

### DETAILED DESCRIPTION

Hereinafter, a light irradiation device of the present disclosure will be described in detail with reference to the accompanying drawings. In the description of the drawings, the same elements are denoted by the same reference signs, and duplicate descriptions will not be repeated. For clarity of description and illustration, the size of each element may be appropriately changed. The size of each element does not necessarily have a size relationship as shown.

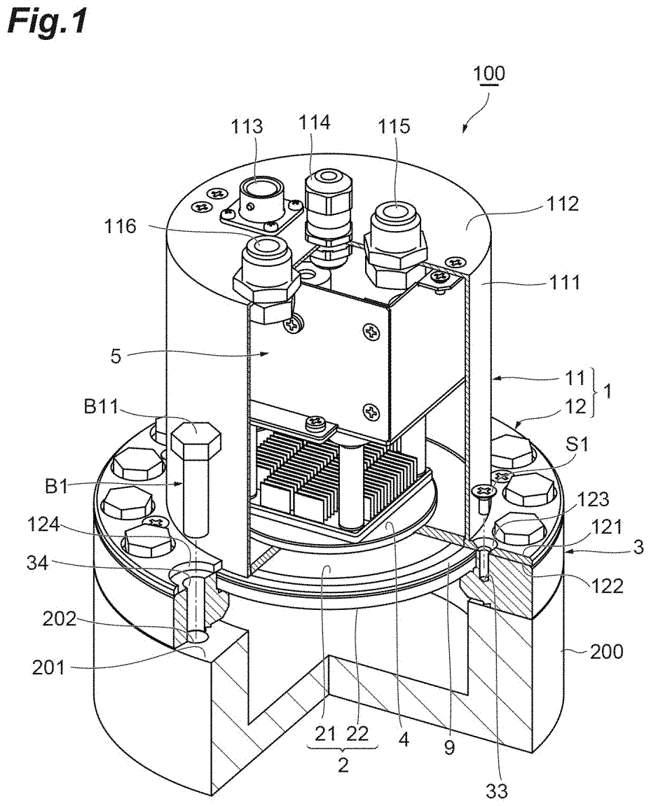

Irradiation light from a light irradiation device 100 shown in FIG. 1 is ultraviolet rays. For example, the irradiation light from the light irradiation device 100 is vacuum ultraviolet light having a wavelength of 172 nm. The irradiation light from the light irradiation device 100 has an intensity per unit area of 100 mW/cm². The light irradiation device 100 is used in, for example, a semiconductor manufacturing apparatus, a vacuum generator, or the like. The light irradiation device 100 is also used to clean the inside of a chamber 200. The light irradiation device 100 of the present disclosure irradiates the inside of the chamber 200 with light.

The light irradiation device 100 includes a housing 1, a vacuum window 2 (window member), and a flange ring 3 (frame member). The housing 1 and the vacuum window 2 form a space that accommodates a lamp 4 that generates light. For example, the chamber 200 is a decompression container. An internal space of the chamber 200 is a decompression environment. The internal space of the chamber 200 is, for example, a vacuum environment. The lamp 4 cannot be disposed in the decompression environment such as a vacuum environment. The lamp 4 is disposed in an atmospheric pressure environment. An environment in which the lamp 4 is disposed differs from an environment of a light irradiation region (internal space of the chamber 200). The housing 1 and the vacuum window 2 form a space that is, for example, the atmospheric pressure environment to protect the lamp 4. The atmospheric pressure environment and the decompression environment are partitioned off from each other by the vacuum window 2.

<Housing>

The housing 1 includes a housing body 11 and a housing flange 12. The housing 1 is made of, for example, stainless steel. The housing body 11 includes a body cylinder 111 and a body top plate 112. The body cylinder 111 has a cylindrical shape. The body top plate 112 is provided at one end portion of the body cylinder 111. The one end portion of the body cylinder 111 is closed by the body top plate 112. An electrical connector 113, a cable connector 114, a suction pipe joint 115, and a discharge pipe joint 116 are disposed on the body top plate 112. Connection members from the outside can be arranged in one direction by arranging connection portions for connection with the outside on the body top plate 112. Therefore, the degree of freedom in the disposition of the light irradiation device 100 can be increased.

The vacuum window 2 is disposed at the other end portion of the body cylinder 111. The other end portion of the body cylinder 111 is closed by the vacuum window 2. The housing flange 12 is provided at the other end portion of the body cylinder 111.

An outer diameter of the housing flange 12 is larger than an outer diameter of the body cylinder 111. The housing flange 12 has a housing flange major surface 121 and a housing flange back surface 122. The housing flange 12 is provided with a plurality of countersinks 123 and a plurality of bolt head holes 124.

The countersinks 123 provided in the housing flange major surface 121 accommodate head portions of respective screws S1. The screws S1 are screwed into respective screw holes 33 provided in the flange ring 3. The flange ring 3 is fixed to the housing flange 12 by the screws S1. The vacuum window 2 is sandwiched between the housing flange 12 and the flange ring 3. The vacuum window 2 is exchangeably fixed by being sandwiched.

The bolt head holes 124 accommodate head portions B11 of respective bolts B1. An inner diameter of the bolt head holes 124 is larger than that of circumscribed circles of the head portions B11 of the bolts B1. The bolt head holes 124 accommodate lower portions of the head portions B11 of the respective bolts B1. Upper portions of the head portions B11 of the bolts B1 protrude from the respective bolt head holes 124. A depth of the bolt head holes 124 is lower than a height of the head portions B11 of the bolts B1. A thickness of the housing flange 12 is smaller than the height of the head portions B11 of the bolts B1.

The bolts B1 are inserted into respective bolt holes 34 of the flange ring 3 to be described later. Tip portions of the bolts B1 are screwed into respective screw holes 202 provided in a chamber attachment surface 201 of the chamber 200. The housing 1 is fixed to the chamber 200.

<Vacuum Window>

The vacuum window 2 is a light-transmitting member that transmits light generated by the lamp 4. The vacuum window 2 is made of, for example, synthetic quartz. The vacuum window 2 is a disk having a circular shape in a plan view. The vacuum window 2 has a vacuum window major surface 21 and a vacuum window back surface 22. The vacuum window major surface 21 receives light from the lamp 4. The vacuum window back surface 22 emits light to the outside of the housing 1. The vacuum window major surface 21 is a light incident surface. The vacuum window back surface 22 is a light-emitting surface.

An outer diameter of the vacuum window 2 is larger than an outer diameter of the housing body 11. The outer diameter of the vacuum window 2 is smaller than the outer diameter of the housing flange 12. An internal space of the housing 1 is the atmospheric pressure environment. The internal space of the chamber 200 is the decompression environment such as a vacuum environment. A force always acts on the vacuum window 2 from the internal space of the housing 1 toward the internal space of the chamber 200. The vacuum window 2 has a strength and a thickness sufficient enough to withstand the force acting from the internal space toward the internal space of the chamber 200.

<Flange Ring>

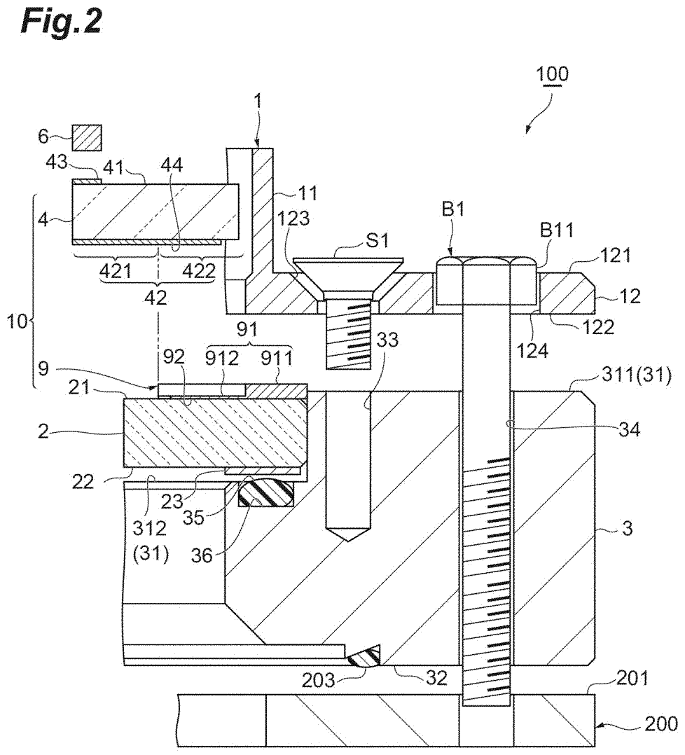

As shown in FIG. 2, the flange ring 3 holds the vacuum window 2 in cooperation with the housing flange 12. The flange ring 3 is made of a stainless alloy. The flange ring 3 has an annular shape. An outer diameter of the flange ring 3 may be the same as the outer diameter of the housing flange 12. An inner diameter of the flange ring 3 may be the same as an inner diameter of the housing body 11.

A flange ring major surface 31 of the flange ring 3 has a flange-facing region 311 facing the housing flange 12, and a vacuum window-facing region 312 facing the vacuum window back surface 22 of the vacuum window 2. The flange-facing region 311 having an annular shape surrounds the vacuum window-facing region 312 having an annular shape. The vacuum window-facing region 312 is located inside the flange-facing region 311. The screw holes 33 are provided in the flange-facing region 311. The screw holes 33 are blind holes. The screw holes 33 are used to fix the housing flange 12 described above to the flange ring 3. The screws S1 are disposed in the respective screw holes 33. The bolt holes 34 are also provided in the flange-facing region 311. The bolt holes 34 are through-holes.

The vacuum window-facing region 312 is recessed with respect to the flange-facing region 311. The vacuum window 2 is fitted into the recess. An outer diameter of the vacuum window-facing region 312 is approximately the same as the outer diameter of the vacuum window 2. The vacuum window 2 is sandwiched between the housing 1 and the flange ring 3. A support ring 9 (support plate) to be described later may be sandwiched between the housing flange 12 and the flange ring 3. A height from the vacuum window-facing region 312 to the flange-facing region 311 may be larger than the thickness of the vacuum window 2. An O-ring seal 35 for ensuring airtightness is disposed between the vacuum window back surface 22 and the vacuum window-facing region 312. The O-ring seal 35 is made of a resin material. A seal groove 36 for disposing the O-ring seal 35 is provided in the vacuum window-facing region 312.

A shielding film 23 is provided on a portion of the vacuum window back surface 22 of the vacuum window 2, the portion facing the vacuum window-facing region 312 of the flange ring 3. The shielding film 23 is, for example, a gold film formed by evaporation. The shape of the shielding film 23 is a circular ring. The shielding film 23 has a width larger than that of the O-ring seal 35 in a plan view. Therefore, an upper surface of the O-ring seal 35 is in contact with the vacuum window 2 in a state where the O-ring seal 35 is covered with the shielding film 23. The shielding film 23 blocks light generated by the lamp 4. The shielding film 23 can prevent that the light generated by the lamp 4 transmits through the vacuum window 2 and the O-ring seal 35 is irradiated with the light.

A flange ring back surface 32 of the flange ring 3 faces the chamber attachment surface 201 of the chamber 200. An O-ring seal 203 for ensuring airtightness may be disposed between the flange ring back surface 32 and the chamber attachment surface 201. The flange ring 3 has the bolt holes 34 for the bolts B1 described above. The bolt holes 34 penetrate from the flange ring major surface 31 to the flange ring back surface 32. Each of the bolt holes 34 is not provided with a screw thread.

<Partition Box>

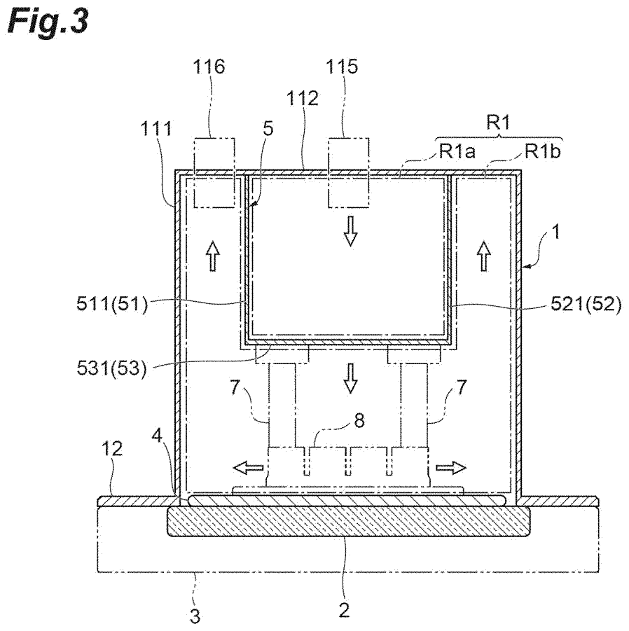

As shown in FIG. 3, the light irradiation device 100 includes a partition box 5 (partition unit). The partition box 5 partitions an internal space R1 of the housing 1 into an upstream space R1a (first space) and a downstream space R1b (second space). The internal space R1 of the housing 1 includes the upstream space R1a and the downstream space R1b. The upstream space R1a is the internal space R1 of the housing 1. The upstream space R1a is the inside of the partition box 5. The downstream space R1b is the internal space R1 of the housing 1. The downstream space R1b is the outside of the partition box 5.

“Upstream” and “downstream” are defined with respect to the flow of gas (heat medium) for cooling the lamp 4 to be described later. The gas moves the outside of the housing 1 to the upstream space R1a through the suction pipe joint 115 (inlet portion). The gas moves from the upstream space R1a to the downstream space R1b. The gas is discharged from the downstream space R1b to the outside of the housing 1 through the discharge pipe joint 116 (outlet portion).

The partition box 5 has a rectangular parallelepiped box shape. The partition box 5 includes four walls 511, 512, 521, and 522 and a bottom portion 531. An upper surface of the partition box 5 is open. The upper surface of the partition box 5 is closed by the body top plate 112. The partition box 5 is in contact with the body top plate 112. The partition box 5 is disposed on a body top plate 112 side in the internal space R1 of the housing 1. As shown in FIG. 1, when the light irradiation device 100 is disposed on the chamber 200, the partition box 5 is disposed on an upper side in the internal space R1 of the housing 1.

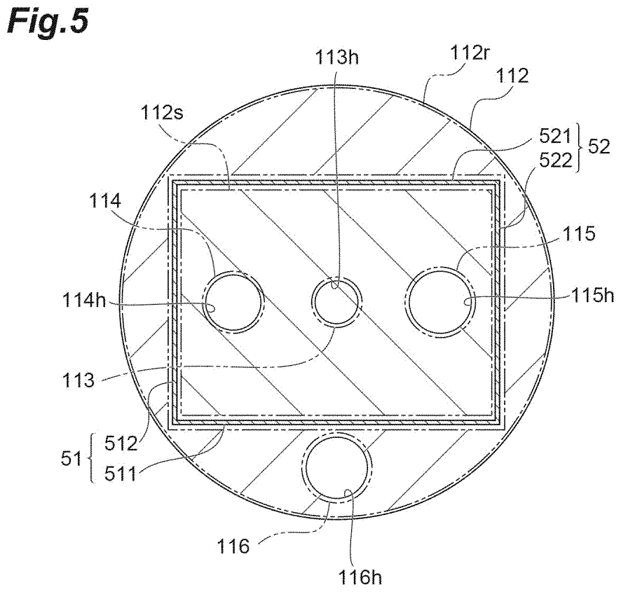

The upstream space R1a is surrounded by inner surfaces of the four walls 511, 512, 521, and 522, the bottom portion 531, and a part of a back surface of the body top plate 112. The back surface of the body top plate 112 has an upstream surface region 112s (refer to FIG. 5) facing the upstream space R1a. A cable port 113h, a suction port 115h, and a connector port 114h are provided in the upstream surface region 112s of the body top plate 112. The shape of the upstream surface region 112s is the same as a plane shape of the partition box 5 in a plan view. The shape of the upstream surface region 112s is a rectangular shape. The cable port 113h is provided substantially at the center of the body top plate 112. The suction port 115h is provided in a short side portion of the upstream surface region 112s having a rectangular shape. The connector port 114h is also provided in a short side portion of the upstream surface region 112s having a rectangular shape.

The downstream space R1b is surrounded by outer surfaces of the four walls 511, 512, 521, and 522, an outer surface of a box bottom plate 53, an inner peripheral surface of the body cylinder 111, and another part of the back surface of the body top plate 112. The back surface of the body top plate 112 further has a downstream surface region 112r facing the downstream space R1b, in addition to the upstream surface region 112s. A discharge port 116h is provided in the downstream surface region 112r of the body top plate 112. A lower portion of the downstream space R1b is closed by the vacuum window 2 described above.

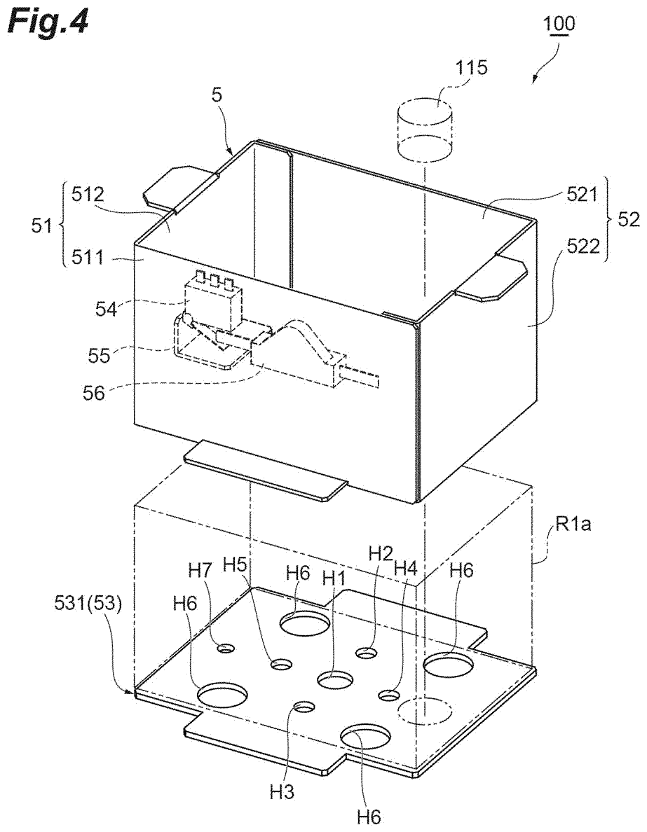

As shown in FIG. 4, the partition box 5 includes a first box wall plate 51, a second box wall plate 52, and the box bottom plate 53.

The first box wall plate 51 forms the walls 511 and 512. The first box wall plate 51 is fixed to the box bottom plate 53. Holes (through-holes) for the flowing of the gas are not provided in the first box wall plate 51.

The second box wall plate 52 forms the walls 521 and 522. The second box wall plate 52 is also fixed to the box bottom plate 53. Holes for the flowing of the gas are also not provided in the second box wall plate 52.

The box bottom plate 53 forms the bottom portion 531. The box bottom plate 53 is fixed to the first box wall plate 51 and to the second box wall plate 52. Holes for the flowing of the gas are provided in the box bottom plate 53. Specifically, five first to fifth holes H1 to H5 are provided in the box bottom plate 53. An inner diameter of the first hole H1 may be larger than an inner diameter of the second to fifth holes H2 to H5. The first hole H1 is provided substantially at the center of the box bottom plate 53. The second to fifth holes H2 to H5 are provided in a cross shape around the box bottom plate 53. The suction pipe joint 115 is provided in the short side portion of the upstream surface region 112s having a rectangular shape. The first to fifth holes H1 to H5 do not overlap on an axis of the suction pipe joint 115. The gas guided from the suction pipe joint 115 collides with the box bottom plate 53. When the gas is supplied to the upstream space R1a, a pressure in the upstream space R1a becomes higher than a pressure in the downstream space R1b. As a result, the gas in the upstream space R1a is pushed out to the downstream space R1b. Therefore, the gas flows out from the upstream space R1a to the downstream space R1b.

The box bottom plate 53 is provided with unit disposition holes H6 in which spacer units 7 to be described later are disposed. The number of the unit disposition holes H6 is 4. When an imaginary rectangular region surrounding the first to fifth holes H1 to H5 is assumed, the unit disposition holes H6 are formed at respective corners of the rectangular region.

Several components forming the light irradiation device 100 are disposed inside the partition box 5. The partition box 5 accommodates, for example, an interlock switch 54, a checker lamp 55, and a temperature sensor 56. The interlock switch 54 stops the driving of the lamp 4 when an abnormality occurs in the light irradiation device 100. As a result, when an abnormality occurs in the light irradiation device 100, irradiation with light is stopped. The interlock switch 54 is fixed to, for example, the wall 511 of the first box wall plate 51. The checker lamp 55 is used when the emission of light from the lamp 4 is started. The checker lamp 55 generates light of a specific wavelength. When the light of the checker lamp 55 is incident on the lamp 4, the generation of light (electrical discharge) in the lamp 4 is easily started. The checker lamp 55 may include, for example, a blue LED as a light source. The checker lamp 55 may include a circuit substrate for operating the light source. The box bottom plate 53 may be provided with a hole H7 for guiding the light of the checker lamp 55.

As shown in FIG. 2, the light irradiation device 100 includes an irradiation unit 10. The irradiation unit 10 is disposed in the downstream space R1b. The irradiation unit 10 includes the lamp 4, a high-voltage electrode plate 6, the spacer units 7, a heat sink 8 (heat discharge unit), and the support ring 9.

<Lamp>

The lamp 4 is supplied with a voltage. The lamp 4 generates light through electrical discharge in an internal space of the lamp 4. For example, the light generated by the lamp 4 is vacuum ultraviolet light. The lamp 4 has a disk shape. An outer diameter of the lamp 4 is slightly smaller than the inner diameter of the housing body 11. The lamp 4 is a so-called excimer lamp. The lamp 4 is a container made of glass. The inside of the lamp 4 is filled with gas for generating light through electrical discharge. The lamp 4 has a lamp major surface 41 (second surface) and a lamp back surface 42 (first surface).

The lamp major surface 41 faces the high-voltage electrode plate 6. A lamp major surface electrode 43 (first electrode) is provided on the lamp major surface 41. The shape of the lamp major surface electrode 43 is a circular shape. The lamp major surface electrode 43 is made of a conductive material. The lamp major surface electrode 43 may be an aluminum film provided by evaporation. With such a configuration, the light generated by the lamp 4 is reflected by the lamp major surface electrode 43. An outer diameter of the lamp major surface electrode 43 is approximately the same as an outer diameter of the high-voltage electrode plate 6. With such a configuration, the amount of light to be emitted from the lamp back surface 42 can be increased.

A lamp back surface electrode 44 (second electrode) is provided on the lamp back surface 42. The lamp back surface electrode 44 is a mesh (net) made of a thin wire-shaped conductive material (for example, gold). In FIG. 2, the lamp back surface electrode 44 is simply shown as having a flat plate shape. With such a configuration, the light generated by the lamp 4 can be emitted from the lamp back surface 42.

The lamp back surface 42 has a vacuum window-facing region 421 and a support ring-facing region 422. The vacuum window-facing region 421 faces the vacuum window 2. The support ring-facing region 422 faces the support ring 9.

The vacuum window-facing region 421 having a circular shape in a plan view is surrounded by the support ring-facing region 422 having an annular shape in a plan view. The vacuum window-facing region 421 is a substantial light emission region of the lamp 4. The lamp back surface electrode 44 may be provided in the vacuum window-facing region 421.

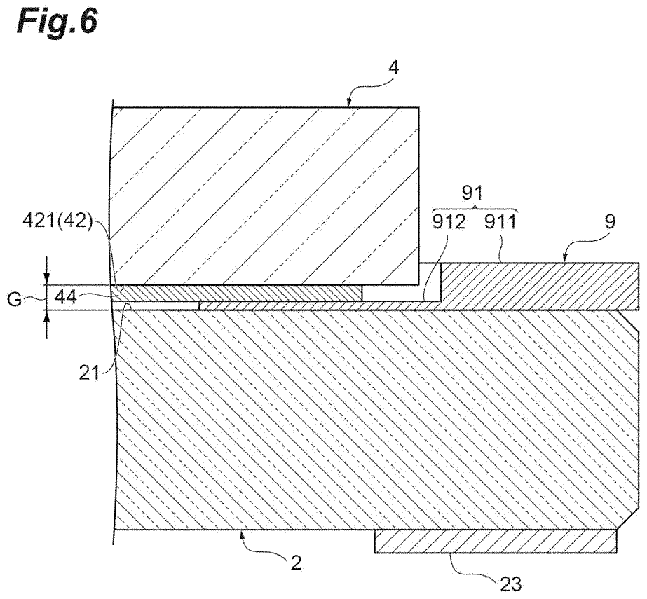

As shown in FIG. 6, the vacuum window-facing region 421 of the lamp back surface 42 faces the vacuum window major surface 21 of the vacuum window 2. The lamp back surface electrode 44 is provided on the lamp back surface 42. The lamp back surface electrode 44 is in contact with a lamp-facing region 912 of a support ring major surface 91. The vacuum window-facing region 421 of the lamp back surface 42 is not in direct contact with the vacuum window major surface 21 of the vacuum window 2. A gap G is generated between the vacuum window-facing region 421 of the lamp back surface 42 and the vacuum window major surface 21 of the vacuum window 2. The gap G corresponds to a thickness of the lamp-facing region 912 of the support ring major surface 91. In addition to the thickness of the lamp-facing region 912, a thickness of the lamp back surface electrode 44 may be added to the definition of the gap G.

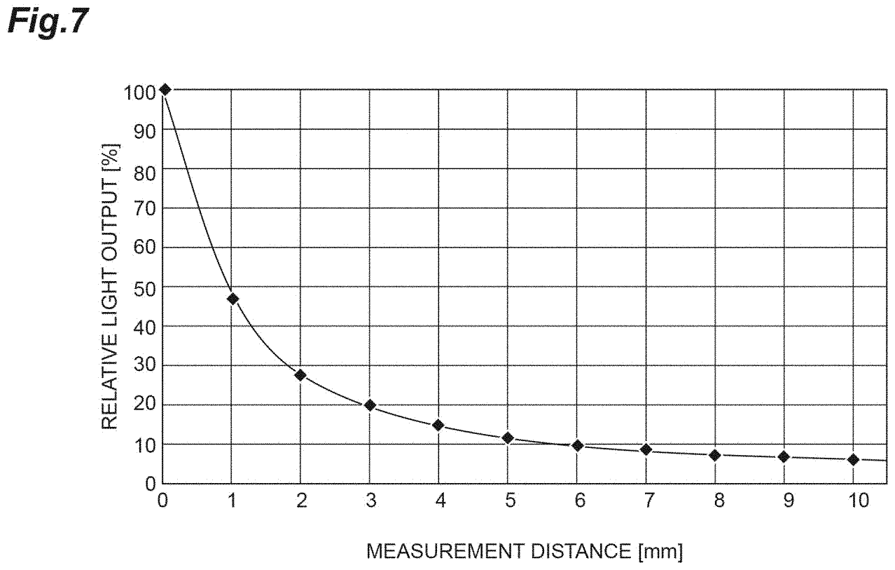

The gap G affects the intensity of the light generated by the lamp 4. FIG. 7 is a graph showing a light output at a position away from the lamp 4 by a predetermined distance. The horizontal axis is a distance with respect to the lamp 4. The vertical axis is a relative output when the light output emitted by the lamp 4 is 100. As shown in FIG. 7, the larger the distance from the lamp 4 is, the more the light output decreases. As is clear from FIG. 7, it is possible to suppress a reduction in light output by bringing the lamp 4 close to the vacuum window 2. The degree of decrease of the light output can be set to a desired value by setting the gap G between the lamp 4 and the vacuum window 2 to a predetermined value.

For example, the gap G between the lamp 4 and the vacuum window 2 may be 0.2 mm or more. The gap G may have a value of 3 mm or less. In this case, it is possible to emit light having an output of approximately 20% of the light generated by the lamp 4. When the gap G is reduced by a predetermined amount, the degree of increase of the light output with respect to the degree of change of the gap G is larger in a region where the gap G is 3 mm or less than in a region where the gap G is greater than 3 mm. In the region where the gap G is 3 mm or less, the effect of the reduction of the gap G is great.

For example, the gap G between the lamp 4 and the vacuum window 2 may have a value of 1 mm or less. When the gap G between the lamp 4 and the vacuum window 2 is 1 mm or less, it is possible to emit light having an output of approximately 50% of the light generated by the lamp 4. When the gap G is reduced by a predetermined amount, the rate of increase of the light output according to the reduction is even larger in a region where the gap G is 1 mm or less than in a region where the gap G is 3 mm or less and greater than 1 mm Namely, in the region where the gap G is 1 mm or less, the effect of the reduction of the gap G is greater.

The support ring-facing region 422 faces the support ring major surface 91 of the support ring 9. The lamp back surface electrode 44 is provided on at least a part of the support ring-facing region 422. The lamp back surface electrode 44 is electrically connected to the support ring 9. The lamp back surface electrode 44 is in direct contact with the support ring 9.

<High-Voltage Electrode Plate>

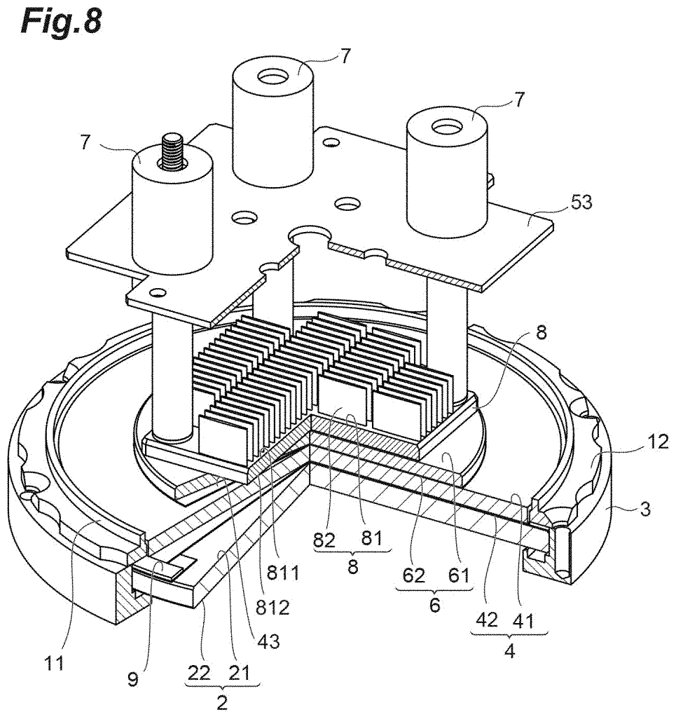

As shown in FIG. 8, the high-voltage electrode plate 6 has a disk shape. The high-voltage electrode plate 6 is made of an aluminum alloy. The outer diameter of the high-voltage electrode plate 6 is smaller than the outer diameter of the lamp 4. The outer diameter of the high-voltage electrode plate 6 is smaller than the inner diameter of the housing body 11. A distance from the high-voltage electrode plate 6 to the housing body 11 is an insulation distance for suppressing electrical discharge. A distance from the high-voltage electrode plate 6 to the support ring 9 is also an insulation distance for suppressing electrical discharge. The high-voltage electrode plate 6 has an electrode plate major surface 61 and an electrode plate back surface 62.

The electrode plate major surface 61 faces the heat sink 8. The electrode plate back surface 62 faces the lamp 4. The electrode plate back surface 62 is in direct surface contact with the lamp major surface electrode 43 provided on the lamp major surface 41 (refer to FIG. 2). The high-voltage electrode plate 6 is pressed against the lamp 4 by a force generated by the spacer units 7. The electrode plate back surface 62 is pressed against the lamp major surface electrode 43 to be in surface contact therewith. Electrical contact resistance between the high-voltage electrode plate 6 and the lamp 4 is reduced by the pressing.

<Heat Sink>

The heat sink 8 is in contact with the high-voltage electrode plate 6. The heat sink 8 is in contact with the electrode plate major surface 61. The heat sink 8 is made of an aluminum alloy. The heat sink 8 includes a heat sink substrate 81 and a plurality of fins 82.

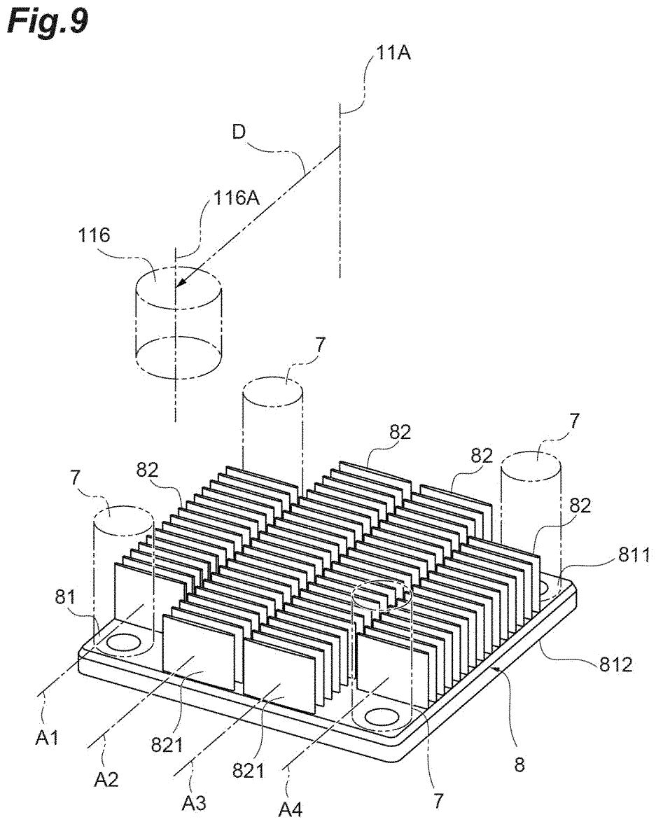

As shown in FIG. 9, the heat sink substrate 81 is a rectangular plate member. For example, the plane shape of the heat sink substrate 81 is a square shape in a plan view. The plane shape of the heat sink substrate 81 may be a circular shape. The heat sink substrate 81 has a heat sink substrate major surface 811 and a heat sink substrate back surface 812. The heat sink substrate major surface 811 faces the partition box 5. The plurality of fins 82 are provided on the heat sink substrate major surface 811. The heat sink substrate back surface 812 faces the electrode plate major surface 61. The heat sink substrate back surface 812 is in surface contact with the electrode plate major surface 61. The lamp major surface electrode 43, the high-voltage electrode plate 6, and the heat sink substrate 81 are all made of a conductive material (here, aluminum) having high thermal conductivity. In addition, the lamp major surface electrode 43, the high-voltage electrode plate 6, and the heat sink substrate 81 are in surface contact with each other. As a result, heat of the lamp 4 is transferred to the heat sink substrate 81 that is an efficient heat discharge unit.

The plurality of fins 82 extend in a wall shape from the heat sink substrate major surface 811 toward the body top plate 112 of the housing 1. Each of the plurality of fins 82 has a thin plate shape. The shapes of the plurality of fins 82 are the same. The plurality of fins 82 are disposed to form a plurality of rows.

As shown in FIG. 9, the plurality of fins 82 are disposed apart from each other along a first alignment axis A1, a second alignment axis A2, a third alignment axis A3, and a fourth alignment axis A4. The alignment axes A1, A2, A3, and A4 are parallel to each other. A direction of the alignment axes A1, A2, A3, and A4 may coincide with a direction D from an axis 11A of the housing body 11 toward an axis 116A of the discharge pipe joint 116.

Fin major surfaces 821 are orthogonal to the respective alignment axes A1, A2, A3, and A4. Namely, normal directions of the fin major surfaces 821 coincide with the respective alignment axes A1, A2, A3, and A4. A gap is provided between the fin major surfaces 821 of the fins 82 facing each other. A gap is also provided between side ends facing each other.

The plurality of fins 82 disposed along the first alignment axis A1 are disposed between a pair of the spacer units 7. The plurality of fins 82 disposed along the fourth alignment axis A4 are disposed between a pair of the spacer units 7. The plurality of fins 82 disposed along the second alignment axis A2 and the third alignment axis A3 are disposed from one side portion to the other side portion of the heat sink substrate 81. Namely, the number of the fins along the second alignment axis A2 and the third alignment axis A3 is larger than the number of the fins 82 along the first alignment axis A1 and the fourth alignment axis A4.

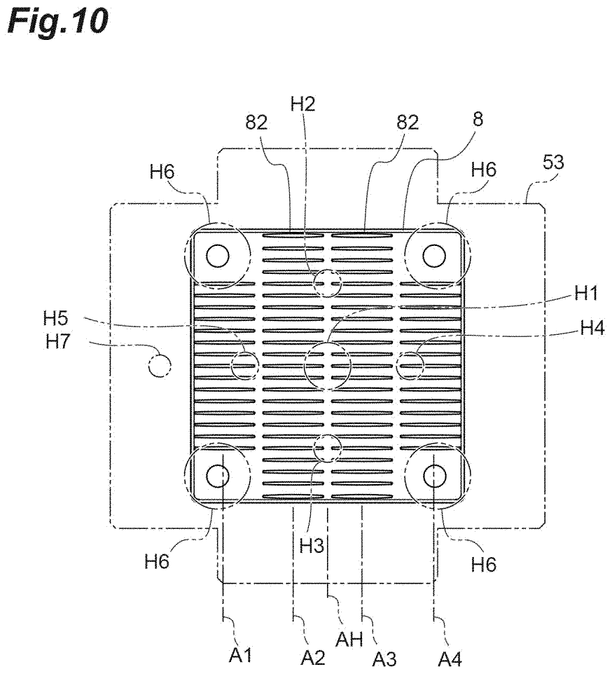

A relationship between the plurality of fins 82 and the holes H1 to H5 of the partition box 5 is as follows. As shown in FIG. 10, for example, a hole axis AH along which the first hole H1, the second hole H2, and the third hole H3 of the partition box 5 are aligned is parallel to the alignment axes A1, A2, A3, and A4. In a plan view, the hole axis AH is located between the second alignment axis A2 and the third alignment axis A3. The hole axis AH overlaps a gap between the side ends of the plurality of fins 82 aligned along the second alignment axis A2 and the side ends of the plurality of fins 82 aligned along the third alignment axis A3. The first hole H1, the second hole H2, and the third hole H3 overlap the plurality of fins 82 along the second alignment axis A2, and the plurality of fins 82 along the third alignment axis A3. The fourth hole H4 overlaps the plurality of fins 82 along the fourth alignment axis A4. The fifth hole H5 overlaps the plurality of fins 82 along the first alignment axis A1.

The high-voltage electrode plate 6 is made of an aluminum alloy. Therefore, a unit in which the high-voltage electrode plate 6 and the heat sink 8 are integrated can be regarded as a heat sink unit. The heat sink 8 is provided on the electrode plate major surface 61 of the high-voltage electrode plate 6. The electrode plate major surface 61 also includes a region exposed from the heat sink 8. Compressed air touches the region exposed from the heat sink 8. Therefore, a part of the electrode plate major surface 61 can also be treated as a heat dissipation surface.

<Support Ring>

As shown in FIG. 2, the support ring 9 has an annular shape. An outer diameter of the support ring 9 may approximately coincide with the outer diameter of the vacuum window 2. An inner diameter of the support ring 9 is smaller than the outer diameter of the lamp 4. The support ring 9 has the support ring major surface 91 and a support ring back surface 92.

The support ring major surface 91 has a flange-facing region (outer peripheral portion) 911 facing the housing flange 12, and a lamp-facing region (inner peripheral portion) 912 facing the lamp 4. The flange-facing region 911 having an annular shape in a plan view is an outer peripheral side of the support ring major surface 91. An outer diameter of the flange-facing region 911 may approximately coincide with the outer diameter of the vacuum window 2. An inner diameter of the flange-facing region 911 may approximately coincide with the inner diameter of the housing body 11. The lamp-facing region 912 having an annular shape in a plan view is an inner peripheral side of the support ring major surface 91. An outer diameter of the lamp-facing region 912 may be slightly larger than the outer diameter of the lamp 4. An inner diameter of the lamp-facing region 912 is smaller than the outer diameter of the lamp 4.

The lamp-facing region 912 faces the lamp back surface 42. The lamp-facing region 912 is electrically connected to the lamp back surface electrode 44. The lamp-facing region 912 is in direct contact with the lamp back surface electrode 44. A thickness of the support ring 9 in the lamp-facing region 912 is sufficiently smaller than a thickness of the support ring 9 in the flange-facing region 911. A thickness of the support ring 9 in the lamp-facing region 912 is extremely thin compared to a thickness of the support ring 9 in the flange-facing region 911. For example, the thickness of the support ring 9 in the lamp-facing region 912 is 0.2 mm. The inner peripheral portion of the support ring 9 including the lamp-facing region 912 is sandwiched between the lamp back surface 42 of the lamp 4 and the vacuum window major surface 21 of the vacuum window 2. The thickness of the inner peripheral portion of the support ring 9 corresponds to a distance from the lamp back surface 42 to the vacuum window major surface 21. The lamp back surface 42 is at such a distance that the lamp back surface 42 does not come into direct contact with the vacuum window major surface 21. The slight gap G is formed between the lamp back surface 42 and the vacuum window major surface 21.

The flange-facing region 911 faces the housing flange back surface 122. The flange-facing region 911 is in direct contact with the housing flange back surface 122. As a result, the lamp back surface electrode 44 of the lamp 4 is electrically connected to the housing 1 via the support ring 9. For example, when the potential of the housing 1 is a ground potential, the lamp back surface electrode 44 of the lamp 4 is supplied with the ground potential.

The support ring back surface 92 faces the vacuum window 2. The support ring back surface 92 is in direct contact with the vacuum window 2.

An inner peripheral portion of the support ring 9 including the lamp-facing region 912 and the support ring back surface 92 is sandwiched between the lamp 4 and the vacuum window 2. An outer peripheral portion of the support ring 9 including the flange-facing region 911 and the support ring back surface 92 is sandwiched between the housing flange 12 and the vacuum window 2. The housing 1 and the flange ring 3 sandwich the support ring 9 and the vacuum window 2 therebetween. The thickness of the support ring 9 in the flange-facing region 911 is sufficiently larger than the thickness of the support ring 9 in the lamp-facing region 912. Therefore, the support ring 9 is reliably sandwiched between the housing flange 12 and the vacuum window 2. As a result, the support ring 9 is stably fixed.

<Spacer Unit>

As shown in FIG. 8, the spacer units 7 press a configuration in which the heat sink 8 and the high-voltage electrode plate 6 are integrated, against the lamp 4.

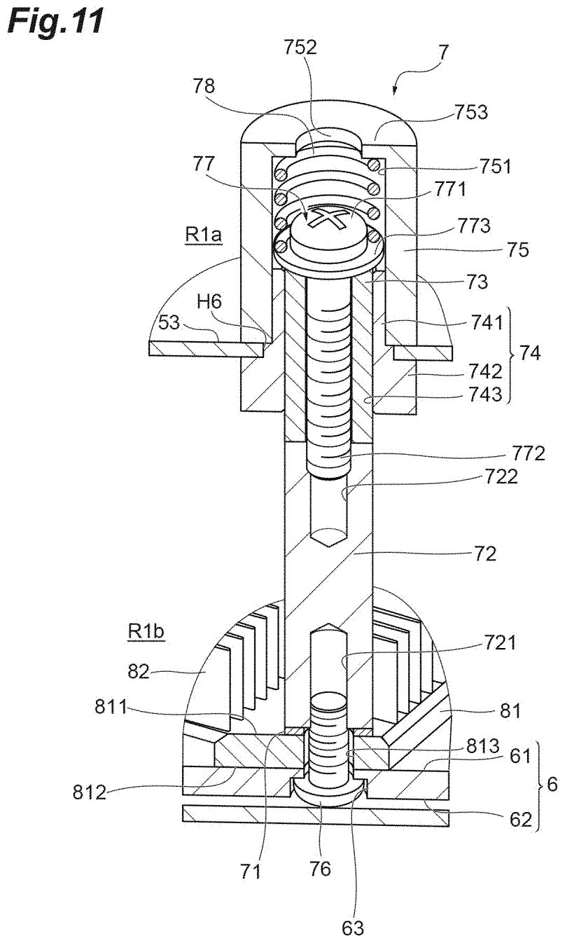

As shown in FIG. 11, the high-voltage electrode plate 6 has electrode plate holes 63. The electrode plate holes 63 reach the electrode plate back surface 62 from the electrode plate major surface 61. The electrode plate holes 63 are holes for fixing the high-voltage electrode plate 6, the heat sink 8, and the spacer units 7 to each other with fixing screws 76. The number of the electrode plate holes 63 is 4. The electrode plate back surface 62 is provided with counterbores that accommodate head portions of the respective fixing screws 76.

The heat sink substrate 81 is provided with heat sink substrate holes 813. The heat sink substrate holes 813 reach the heat sink substrate back surface 812 from the heat sink substrate major surface 811. The heat sink substrate holes 813 are provided at respective corners of the heat sink substrate 81 having a rectangular shape. The heat sink substrate holes 813 are coaxial with the respective electrode plate holes 63 of the high-voltage electrode plate 6. The fixing screws 76 are inserted into the respective electrode plate holes 63. The fixing screws 76 pass through the respective electrode plate holes 63 and through the respective heat sink substrate holes 813. The fixing screws 76 are screwed into the respective spacer units 7. With this configuration, the high-voltage electrode plate 6, the heat sink 8, and the spacer units 7 are integrated by the fixing screws 76.

The lamp 4 is pressed against the support ring 9 by a force received from the high-voltage electrode plate 6. The magnitude of a force generated by a spring 78 to be described later can be set to a desired magnitude by setting a compression length of the spring 78. As a result, the high-voltage electrode plate 6 and the lamp major surface electrode 43 of the lamp 4 can be brought into good close contact with each other without damaging the lamp 4 made of glass.

Each of the spacer units 7 includes a washer 71, a spacer body 72, a metal spacer 73, a plug 74, and a socket 75. Each of the spacer units 7 includes the fixing screw 76, a washer head screw 77, and the spring 78.

The washer 71 having a disk shape is disposed on the heat sink substrate major surface 811 of the heat sink substrate 81. The washer 71 is disposed in the downstream space R1b. A nickel strand wire is connected to one of four washers 71. A power supply cable is drawn into the upstream space R1a from the cable connector 114. The power supply cable is covered with an insulating sheath. The nickel strand wire is disposed in the upstream space R1a in a state where the nickel strand wire covered with the insulating sheath is exposed by removing the insulating sheath. The nickel strand wire reaches the downstream space R1b via the first hole H1. For example, a so-called round terminal to which a tip of the nickel strand wire can be connected may be used as the washer 71. As a result, the high-voltage electrode plate 6 is supplied with a voltage via the washer 71 and via the heat sink substrate 81.

The spacer body 72 having a columnar shape is disposed on the washer 71. The spacer body 72 is disposed in the downstream space R1b. The spacer body 72 is made of a material having electrical insulation. The spacer body 72 is made of, for example, ceramic. Screw holes 721 and 722 are provided at both ends of the spacer body 72. A thread corresponding to the fixing screw 76 is formed in the screw hole 721. A thread corresponding to the washer head screw 77 is formed in the screw hole 722. Each of the screw holes 721 and 722 is a blind hole.

A lower end surface of the spacer body 72 is in contact with the washer 71. The spacer body 72 is fixed to the heat sink 8 by the fixing screw 76 inserted from the electrode plate back surface 62 of the high-voltage electrode plate 6. The metal spacer 73 is disposed on an upper end surface of the spacer body 72. The upper end surface of the spacer body 72 is closer to the partition box 5 than tips of the fins 82. A height of the spacer body 72 is larger than a height of the fins 82 with respect to the heat sink substrate major surface 811 of the heat sink substrate 81.

The washer head screw 77 includes a head 771. A shaft portion 772 of the washer head screw 77 is inserted into the metal spacer 73. A tip portion of the washer head screw 77 is screwed into the screw hole 722 of the spacer body 72. A nominal length of the washer head screw 77 is longer than a length of the metal spacer 73. As a result, the metal spacer 73 is sandwiched between the head 771 and the spacer body 72.

The washer head screw 77 is disposed from the upstream space R1a to the downstream space R1b. The head 771 of the washer head screw 77 is disposed in the upstream space R1a. The tip portion of the washer head screw 77 is disposed in the downstream space R1b. The box bottom plate 53 of the partition box 5 is provided with the unit disposition holes H6. The washer head screws 77 penetrate through the respective unit disposition holes H6.

A washer 773 is disposed between the head 771 and the metal spacer 73. The washer 773 may be integrated with the head 771. The washer 773 may separate from the head 771. An outer diameter of the washer 773 is larger than an outer diameter of the head 771. The outer diameter of the washer 773 is larger than an outer diameter of the metal spacer 73. The spring 78 is disposed between the washer 773 and a socket lid surface 753 of the socket 75. The spring 78 is a compression spring. The spring 78 is disposed between the washer 773 and the socket lid surface 753 in a state where the spring 78 is compressed from a natural length thereof. As a result, the spring 78 exerts a force to press the washer 773 toward the metal spacer 73. The spacer unit 7 presses the configuration in which the heat sink 8 and the high-voltage electrode plate 6 are integrated, against the lamp 4 by means of the force of the spring 78.

Similarly to the washer head screw 77, the metal spacer 73 is disposed from the upstream space R1a to the downstream space R1b. An upper end of the metal spacer 73 is in contact with the head 771. The upper end of the metal spacer 73 is disposed in the upstream space R1a. A lower end of the metal spacer 73 is in contact with the spacer body 72. The lower end of the metal spacer 73 is disposed in the downstream space R1b. The box bottom plate 53 of the partition box 5 is provided with the unit disposition holes H6. The metal spacers 73 also penetrate through the respective unit disposition holes H6.

The metal spacer 73 is supported by the plug 74. The shape of the plug 74 is a stepped cylindrical shape. The plug 74 is inserted into the unit disposition hole H6 from a back surface of the box bottom plate 53. A plug body 741 is a portion of the plug 74, of which the outer diameter is small. The plug body 741 is inserted into the unit disposition hole H6. An outer diameter of the plug body 741 may be approximately the same as an inner diameter of the unit disposition hole H6. A tip of the plug body 741 is disposed in the upstream space R1a. A plug flange 742 is a portion of the plug 74, of which the outer diameter is large. The plug flange 742 abuts on the back surface of the box bottom plate 53. An outer diameter of the plug flange 742 is larger than the inner diameter of the unit disposition hole H6. The plug 74 is provided with a plug hole 743. The plug hole 743 reaches an end surface of the plug flange 742 from an end surface of the plug body 741. The metal spacer 73 is disposed in the plug hole 743. The washer head screw 77 is inserted into the metal spacer 73. An upper end of the metal spacer 73 protrudes from the end surface of the plug body 741. The lower end of the metal spacer 73 protrudes from a lower end of the plug flange 742. A length of the plug 74 is shorter than a length of the metal spacer 73.

A thread is formed on an outer peripheral surface of the plug body 741. The thread of the plug body 741 is screwed into the socket 75. The socket 75 is disposed in the upstream space R1a. The socket 75 has a cylindrical shape. A socket screw hole 751 into which the plug 74 is screwed opens at a lower end of the socket 75. The lower end of the socket 75 is in contact with a major surface of the box bottom plate 53. The plug 74 is inserted into the unit disposition hole H6 from the back surface of the box bottom plate 53. When the plug 74 is screwed into the socket 75, the plug 74 and the socket 75 sandwich the box bottom plate 53 therebetween. With this configuration, the plug 74 and the socket 75 are fixed to the partition box 5. A socket hole 752 is provided at an upper end of the socket 75. The socket hole 752 is a hole into which a tool for tightening the washer head screw 77 is inserted.

A cooling function of the lamp 4 of the light irradiation device 100 will be described. The light irradiation device 100 may use compressed air as the gas used as a heat medium. The light irradiation device 100 may use nitrogen as the gas used as a heat medium. When nitrogen is used, it is possible to suppress a reduction in the intensity of light. The compressed air can be easily prepared compared to nitrogen or the like. According to experiments of the inventors, the intensity of light emitted from the light irradiation device 100 in the case of using air is lower than the intensity of light emitted from the light irradiation device 100 in the case of using nitrogen. However, it has been found that the degree of decrease of the intensity of light is not significant to affect performance. Therefore, even in the case of using air, the light irradiation device 100 can perform irradiation with light requiring a desired intensity.

The compressed air is supplied to the upstream space R1a via the suction pipe joint 115. When the compressed air is supplied to the upstream space R1a, the internal pressure of the upstream space R1a increases. The compressed air present in the upstream space R1a moves from the upstream space R1a to the downstream space R1b through the first to fifth holes H1 to H5. The compressed air that has moved to the downstream space R1b passes through the gaps between the plurality of fins 82. The flow of the compressed air may be in a mode in which heat exchange between the fins 82 and the compressed air is easily performed. For example, the flow of the compressed air may be a turbulent flow. The compressed air may pass through locations at which a temperature difference between the compressed air and the fins 82 is large.

Heat generated by the lamp 4 is transferred to the fins 82. As a result, the heat of the fins 82 is transferred from the fins 82 to the compressed air according to a temperature difference between the temperature of the compressed air and the temperature of the fins 82. The temperature of the compressed air that has received the heat rises according to the amount of the received heat. A density of the compressed air that has received the heat is relatively smaller than a density of the compressed air that has not received the heat. As a result, the compressed air that has received the heat moves toward an outer periphery of the housing body 11. Thereafter, the compressed air is discharged to the outside of the housing 1 via the discharge pipe joint 116.

Heat of the lamp 4 will be described in further detail. The lamp 4 is supplied with a voltage as energy. In addition, the lamp 4 generates light. However, all the received energy is not converted into light. Energy that is not converted into light is converted into heat. There, the lamp 4 generates heat. The heat generated by the lamp 4 is transferred according to a basic form of heat transfer. The heat generated by the lamp 4 is transferred by heat conduction, heat radiation, or heat convection. The heat generated inside the lamp 4 is transferred between the lamp major surface 41 and the lamp back surface 42 by heat conduction.

For example, heat transfer from the lamp back surface 42 will be reviewed. The heat that has been transferred to the lamp back surface 42 that emits light is transferred from the lamp back surface 42 to the air present in the gap between the lamp 4 and the vacuum window 2. The heat that has been transferred to the air is transferred to the vacuum window 2. It can be expected that the heat that has been transferred to the vacuum window 2 is discharged from the vacuum window back surface 22 of the vacuum window 2. However, as described above, the vacuum window back surface 22 of the vacuum window 2 is exposed to the inside of the chamber 200. The inside of the chamber 200 is decompressed. The amount of the medium (gas) for transferring the heat from the vacuum window back surface 22 is extremely small. As a result, almost no heat discharge by heat conduction from the vacuum window back surface 22 can be anticipated. The heat that has been transferred to the vacuum window 2 is discharged by heat radiation as infrared rays, or is discharged by heat conduction via the support ring 9 and the O-ring seal 35 that are in direct contact with the vacuum window 2. However, since the vacuum window 2 is made of quartz, the vacuum window 2 has lower thermal conductivity than those of metal materials. As a result, almost no heat discharge from the lamp back surface 42 can be anticipated.

Next, heat transfer from the lamp major surface 41 will be reviewed. Heat that has been transferred to the lamp major surface 41 is transferred to the lamp major surface electrode 43 that is an aluminum film. The high-voltage electrode plate 6 is pressed against the lamp major surface electrode 43. The pressing is advantageous in terms of reducing electrical resistance. The pressing is advantageous in terms of reducing thermal resistance. Therefore, the heat is transferred from the lamp major surface electrode 43 to the high-voltage electrode plate 6 by heat conduction. The heat is transferred from the high-voltage electrode plate 6 to the heat sink 8 in contact with the high-voltage electrode plate 6 by heat conduction. The heat is transferred to the fins 82 of the heat sink 8 by heat conduction. The heat that has been transferred to the fins 82 is transferred from the fins 82 to the compressed air.

Since so-called thermal resistance is large on a lamp back surface 42 side, heat discharge cannot be anticipated. Thermal resistance is smaller on a lamp major surface 41 side than on the lamp back surface 42 side. The heat generated by the lamp 4 is easily transferred on the lamp major surface 41 side. A difference in the ease of heat transfer can also be considered as a difference in heat dissipation area contributing to heat discharge. A surface area of the plurality of fins 82 occupies the majority of a heat dissipation area contributing heat discharge on the lamp major surface 41 side on which the heat is easily transferred. The heat dissipation area contributing heat discharge on the lamp major surface 41 side is larger than a heat dissipation area contributing heat discharge on the lamp back surface 42 side. For example, the heat dissipation area is represented by ratio. When it is assumed that the heat dissipation area contributing to heat discharge on the lamp back surface 42 side is “1”, the heat dissipation area contributing to heat discharge on the lamp major surface 41 side is approximately “115”.

The heat continues to be discharged from the fins 82. Therefore, the temperature difference between the temperature of the lamp 4 and the temperature of the fins 82 tends to increase. A temperature difference occurring on the lamp major surface 41 side is larger than a temperature difference occurring on the lamp back surface 42 side. Heat is easily transferred in a direction in which the temperature difference is large. The heat generated by the lamp 4 is easily transferred to the lamp major surface 41 side. The amount of the heat transferred to the lamp back surface 42 side is relatively small.

As a result, it is possible to suppress an excessive increase in the temperature of the lamp 4. Therefore, it is possible to suppress the shortening of the life span of the lamp 4 caused by high temperature. It is possible to suppress the rise of temperature of the components existing on the lamp back surface 42 side. For example, the O-ring seal 35 made of resin is in contact with the vacuum window back surface 22 of the vacuum window 2. A state where the temperature of the O-ring seal 35 is lower than a heat-resistant temperature can be maintained by suppressing the rise of temperature of the vacuum window 2.

The light irradiation device 100 can sufficiently cool the lamp 4 by supplying the compressed air. The cooling of the light irradiation device 100 can be dealt with by an air cooling mechanism. The light irradiation device 100 does not need to include a water cooling mechanism that uses water as a heat medium.

The light irradiation device 100 has a further advantage that is different from the advantage of heat discharge.

The flow of the compressed air is limited in a direction from the upstream space R1a toward the downstream space R1b. When the compressed air is present in the downstream space R1b, the compressed air receives strong ultraviolet rays generated by the lamp 4. Ozone may be generated as a result of the compressed air's reception of the ultraviolet rays. The compressed air present in the downstream space R1b contains a larger amount of ozone than the compressed air present in the upstream space R1a, in addition to nitrogen and oxygen. There is a possibility that ozone affects components forming the light irradiation device 100, particularly electronic components. Examples of the components that are likely to be affected by ozone include the interlock switch 54, the checker lamp 55, and the temperature sensor 56. Therefore, it is better not to expose these components to the compressed air that has received the ultraviolet rays. The components that are likely to be affected by ozone are disposed inside the partition box 5. In other words, the components that are likely to be affected by ozone are disposed in the upstream space R1a. The upstream space R1a is filled with fresh compressed air that has been just supplied. Therefore, the components disposed in the upstream space R1a are less likely to be affected by ozone than when the components are disposed in the downstream space R1b. As a result, the components forming the light irradiation device 100 can be protected.

<Actions and Effects>

Actions and effects of the light irradiation device 100 of the present disclosure will be described.

The light irradiation device 100 includes the lamp 4 that has the lamp back surface 42 on which the lamp back surface electrode 44 is provided, and the lamp major surface 41 which faces the lamp back surface 42 and on which the lamp major surface electrode 43 is provided, and that emits light from the lamp back surface 42; the housing 1 forming the internal space R1 in which the lamp 4 is disposed, together with the vacuum window 2 that transmits the light emitted by the lamp 4; and the heat sink 8 that discharges heat from the lamp 4. The heat sink 8 is thermally connected to the lamp major surface 41. The housing 1 includes the suction pipe joint 115 serving as an inlet for compressed air to be supplied to the internal space R1, and the discharge pipe joint 116 serving as an outlet for the compressed air that has received heat from the heat sink 8.

The heat sink 8 is thermally connected to the lamp major surface 41 of the lamp 4. When heat is removed from the lamp major surface 41, a thermal gradient between the inside of the lamp 4 and the lamp major surface 41 increases. As a result, the heat generated by the lamp 4 is easily transferred toward the lamp major surface 41. Therefore, the heat generated by the lamp 4 can be actively discharged from the lamp major surface 41. As a result, the ability to cool the lamp 4 is increased. Therefore, the lamp 4 and the vacuum window 2 can be brought close to each other.

The light irradiation device 100 further includes the partition box 5 that partitions the internal space R1 of the housing 1 into the upstream space R1a and the downstream space R1b. The suction pipe joint 115 communicates with the upstream space R1a. The discharge pipe joint 116 communicates with the downstream space R1b. According to this configuration, the flow of the heat medium can be limited in one direction from the suction pipe joint 115 toward the discharge pipe joint 116. Therefore, the flow of the heat medium becomes smooth. As a result, the ability to cool the lamp 4 is increased.

The lamp 4 of the light irradiation device 100 is disposed in the downstream space R1b. According to this configuration, the heat from the lamp 4 can be efficiently released to the outside of the housing 1.

The partition box 5 of the light irradiation device 100 has the first to fifth holes H1 to H5 that guide the heat medium from the upstream space R1a to the downstream space R1b. According to this configuration, the upstream space R1a and the downstream space R1b can be partitioned off from each other. According to this configuration, the compressed air can be guided from the upstream space R1a to the downstream space R1b.

The partition box 5 of the light irradiation device 100 has a box shape. The upstream space R1a is the inside of the partition box 5. The downstream space R1b is the outside of the partition box 5. According to this configuration, the heat medium in the upstream space R1a and the heat medium in the downstream space R1b can be reliably separated from each other. According to this configuration, it is possible to suppress an influence of the heat medium in the downstream space R1b on the fresh heat medium that has entered the upstream space R1a. For example, it is possible to suppress an influence of heat from the lamp 4 and ozone generated in the downstream space R1b, on the upstream space R1a.

The light irradiation device 100 further includes the support ring 9 in electrical contact with the lamp 4. The inner peripheral portion of the support ring 9 is in contact with an outer peripheral portion of the lamp 4. The outer peripheral portion of the support ring 9 is in contact with the housing 1. According to this configuration, a desired potential can be applied to the lamp 4 via the support ring 9 and via the housing 1.

The support ring major surface 91 is in contact with the lamp back surface electrode 44. According to this configuration, a desired potential can be applied to the lamp back surface electrode 44 of the lamp 4 via the support ring 9 and via the housing 1.

The support ring back surface 92 faces the vacuum window 2. The thickness of the inner peripheral portion of the support ring 9 is smaller than the thickness of the outer peripheral portion of the support ring 9. According to this configuration, the lamp 4 can be brought close to the vacuum window 2.

The light irradiation device 100 further includes the flange ring 3 that sandwiches the vacuum window 2, together with the housing 1. According to this configuration, the vacuum window 2 can be exchangeably fixed to the housing 1.

The vacuum window 2 of the light irradiation device 100 includes the shielding film 23 that is provided on the vacuum window back surface 22 facing the flange ring 3, to block light. According to this configuration, the O-ring seal 35 disposed between the vacuum window 2 and the flange ring 3 can be protected from the light generated by the lamp 4.

The distance between the lamp back surface 42 of the lamp 4 of the light irradiation device 100 and the vacuum window major surface 21 of the vacuum window 2 facing the lamp back surface 42 of the lamp 4 may be 3 mm or less. The distance between the lamp back surface 42 and the vacuum window major surface 21 may be 1 mm or less. According to this configuration, it is possible to sufficiently suppress loss of the light emitted by the lamp. Ultraviolet light, for example, vacuum ultraviolet light having a wavelength of 200 nm or less is absorbed by oxygen in the air. As a result, the amount of the vacuum ultraviolet light may be extremely attenuated even at a short distance. Therefore, when air is used as a heat medium, the distance between the lamp 4 and the vacuum window 2 (gap G) is set to be as small as possible. When air is used as a heat medium, loss of the light can be kept at its minimum.

The light irradiation device 100 of the present disclosure has been described in detail above. However, the light irradiation device 100 of the present disclosure is not limited to the contents of the above description. Various modifications can be made to the light irradiation device 100 of the present disclosure without departing from the concept of the present disclosure. For example, the light irradiation device may not be configured such that the upstream space R1a and the downstream space R1b are partitioned off from each other by the partition box 5 having a box shape. The light irradiation device may be such that the internal space R1 of the housing 1 is partitioned into two spaces in an up-down direction by a plate. The electrical connector 113, the cable connector 114, the suction pipe joint 115, and the discharge pipe joint 116 are not limited to being provided on the body top plate 112. The electrical connector 113, the cable connector 114, the suction pipe joint 115, and the discharge pipe joint 116 may be provided on the body cylinder 111.

What is claimed is:

1. A light irradiation device comprising:
a lamp that has a first surface on which a first electrode is provided, and a second surface which faces the first surface and on which a second electrode is provided, and that emits light from the first surface;
a housing forming an internal space in which the lamp is disposed, together with a window member that transmits the light emitted by the lamp; and
a heat discharge unit that discharges heat generated by the lamp,
wherein the heat discharge unit includes a heat sink thermally connected to the second surface, and
the housing includes an inlet portion serving as an inlet for a heat medium that is gas to be supplied to the internal space, and an outlet portion serving as an outlet for the heat medium that has received the heat from the heat sink.

2. The light irradiation device according to claim 1, further comprising:
a partition unit that partitions the internal space of the housing into a first space and a second space,
wherein the inlet portion communicates with the first space, and
the outlet portion communicates with the second space.

3. The light irradiation device according to claim 2,
wherein the lamp is disposed in the second space.

4. The light irradiation device according to claim 2,
wherein the partition unit has a hole that guides the heat medium from the first space to the second space.

5. The light irradiation device according to claim 2,
wherein the partition unit has a box shape,
the first space is an inside of the partition unit, and
the second space is an outside of the partition unit.

6. The light irradiation device according to claim 1, further comprising:
a support plate in electrical contact with the lamp,
wherein an inner peripheral portion of the support plate is in contact with an outer peripheral portion of the lamp, and an outer peripheral portion of the support plate is in contact with the housing.

7. The light irradiation device according to claim 6,
wherein a first surface of the support plate is in contact with the first electrode.

8. The light irradiation device according to claim 6,
wherein a second surface of the support plate faces the window member, and a thickness of the inner peripheral portion of the support plate is smaller than a thickness of the outer peripheral portion of the support plate.

9. The light irradiation device according to claim 6, further comprising:
a frame member that sandwiches the window member, together with the housing.

10. The light irradiation device according to claim 9,
wherein the window member includes a shielding film that is provided on a surface facing the frame member, to block the light.

11. The light irradiation device according to claim 1,
wherein a distance between the first surface of the lamp and the surface of the window member facing the first surface of the lamp is 3 mm or less.

12. The light irradiation device according to claim 11,
wherein the distance is 1 mm or less.
